(19) United States
(12) Patent Application Publication
(10) Pub. No.: US 2021/0387411 A1
(43) Pub. Date: Dec. 16, 2021

(54) Fused Deposition Modeling Mixing Extruder Coupled to an External Energy Source

(71) Applicant: SAVANNAH RIVER NUCLEAR SOLUTIONS, LLC, Aiken, SC (US)

(72) Inventors: Aaron L. WASHINGTON, II, Aiken, SC (US); Donald W. BENZA, Aiken, SC (US); Khai V. NGUYEN, Aiken, SC (US)

(21) Appl. No.: 16/898,945

(22) Filed: Jun. 11, 2020

(51) Int. Cl. B29C 64/209; B29C 64/118; B29C 64/268; B33Y 30/00; B33Y 10/00

(52) U.S. Cl. CPC B29C 64/209; B29C 64/118; B29K 2075/00; B33Y 30/00; B33Y 10/00; B29C 64/268

(57) ABSTRACT

Methods and systems for use in additive manufacturing are described. Methods include heating a precursor material in a mixing area upstream of a print head nozzle. An energy emission is delivered to the precursor material prior to extrusion at the nozzle. The energy emission encouraging reaction of components in the precursor material to form a solid product of the extrudate such as a polymer, a crosslinked polymeric matrix, and/or a particulate. Systems include a mixing area upstream of a nozzle and an energy source configured to deliver an emission into the mixing area at or near the nozzle outlet.

### FEDERAL RESEARCH STATEMENT

This invention was made with Government support under Contract No. DE-AC09-08SR22470, awarded by the United States Department of Energy. The Government has certain rights in the invention.

### BACKGROUND

Additive manufacturing refers to any method for forming a three-dimensional object in which materials are deposited according to a controlled deposition and/or solidification process. The main differences between additive manufacturing processes are the types of materials to be deposited and the way the materials are deposited and solidified. Some methods extrude materials including liquids (e.g., melts or gels) and extrudable solids (e.g., clays or ceramics) to produce a layer, followed by spontaneous or controlled curing of the extrudate in the desired pattern. Other processes deposit solids in the form of powders or thin films, followed by the application of energy and/or binders often in a focused pattern to join the deposited solids and to form a single, solid structure having the desired shape. In fused deposition modeling approaches, extrudate is deposited from a nozzle that can be moved in multiple planes. Successive layers are individually deposited and solidified prior to deposition of the succeeding layer, with each successive layer becoming adhered to the previous layer during the deposition/solidification process.

In conventional fused deposition modeling, the build material is extruded as a melt directly onto the print bed or onto a previously deposited layer. Useful materials are those that are spatially locked in place (i.e., solidified) immediately after deposition and that maintain spatial characteristics during thermal cycling as each successive build layer is deposited. Since the method includes localized heating at the point of deposition to promote layer-to-layer fusion, either from the extruded material alone or with the addition of energy from an external source, part distortion as successive layers are laid down has been a problem in many applications.

Unfortunately, utilization of materials that exhibit no distortion following initial solidification with thermal cycling that could avoid such issues, and that could be used to build high-strength products, remains elusive. Materials that solidify quickly and adhere strongly to previously deposited material via crosslinking or some other chemical reaction and that exhibit no post-deposition thermally-induced distortion have proven difficult to utilize in additive manufacturing. When utilized in conventional fused deposition protocols, potential materials either solidify too soon, particularly on the outer surface or the extruded bead, before deposition, and/or complete adhesion to the previous layer, or too late, after deposition, leading to deformation and loss of the desired shape of the extrudate.

What is needed in the art are devices and methods that can encourage reactive formation of a material beginning immediately prior to extrusion in order that the extrudate is suitably solidified so as to retain the extruded shape/form while still exhibiting adhesion capability to fully adhere to the previous layer.

### SUMMARY

According to one embodiment, disclosed is an additive manufacturing print head that includes a mixing area. The mixing area includes first and second inlets and an outlet that leads to a nozzle. The extruder also includes a heater in thermal communication with the mixing area and an energy source that is configured to deliver an emission from the energy source into the mixing area at or near the outlet.

Also disclosed is an additive manufacturing method that includes feeding a first precursor material and a second precursor material to a mixing area of an additive manufacturing print head. The method also includes mixing and heating the first material and the second material within the mixing area to form a liquified mixture. The method further includes delivering an energy emission from an energy source to the liquified mixture within the mixing area. Upon the mixing, and in response to the delivered energy, components of the first and second precursor materials interact, the interaction forming a product via, e.g., crosslinking, polymerization, solidification, and/or other chemical reaction. Following the delivery of the energy emission, a polymeric composition that includes the nascent product can be extruded through a nozzle.

### BRIEF DESCRIPTION OF THE FIGURES

A full and enabling disclosure of the present subject matter, including the best mode thereof to one of ordinary skill in the art, is set forth more particularly in the remainder of the specification, including reference to the accompanying figures in which:

FIG. 1 schematically illustrates a portion of a print head of an additive manufacturing extruder as described herein.

FIG. 2 schematically illustrates a portion of a print head of an additive manufacturing extruder as described herein.

Repeat use of reference characters in the present specification and drawings is intended to represent the same or analogous features or elements of the present invention.

### DETAILED DESCRIPTION

Reference will now be made in detail to various embodiments of the disclosed subject matter, one or more examples of which are set forth below. Each embodiment is provided by way of explanation of the subject matter, not limitation thereof. In fact, it will be apparent to those skilled in the art that various modifications and variations may be made in the present disclosure without departing from the scope or spirit of the subject matter. For instance, features illustrated or described as part of one embodiment, may be used in another embodiment to yield a still further embodiment.

Disclosed are systems and methods that can be used to form three-dimensional objects according to an additive manufacturing process. Beneficially, the systems and methods can form products from build materials that have been difficult or impossible to produce previously by additive manufacturing methodology. As utilized herein, the term additive manufacturing refers to a formation method in which materials are formed according to a controlled, incremental deposition and/or solidification process. In general, disclosed systems and methods can be utilized in a fused deposition manufacturing process, in which extrudate in a flowable state flows through a print nozzle and adheres as a solid to a print bed or to material previously deposited on a print bed.

As used herein, the term “a flowable state” of a build material is a state wherein the material is unable to resist shear stresses that are induced by a print head, causing the material to move or flow through a nozzle. In general, the flowable state of the build material is a liquid state; however, the flowable state of the build material may also exhibit thixotropic-like properties. The term “solidified” and “solidifiable” as used herein refer to the phase change characteristics of a material where the material transitions from the flowable state to a non-flowable state. A “solidified” build material generally refers to a state wherein the material is sufficiently self-supportive under its own weight so as to hold its own shape. In addition, the term “cured” or “curable” refers to any polymerization reaction including crosslinking of monomers and oligomers, polymerization of monomers or oligomers, and chain extension of oligomers or polymers.

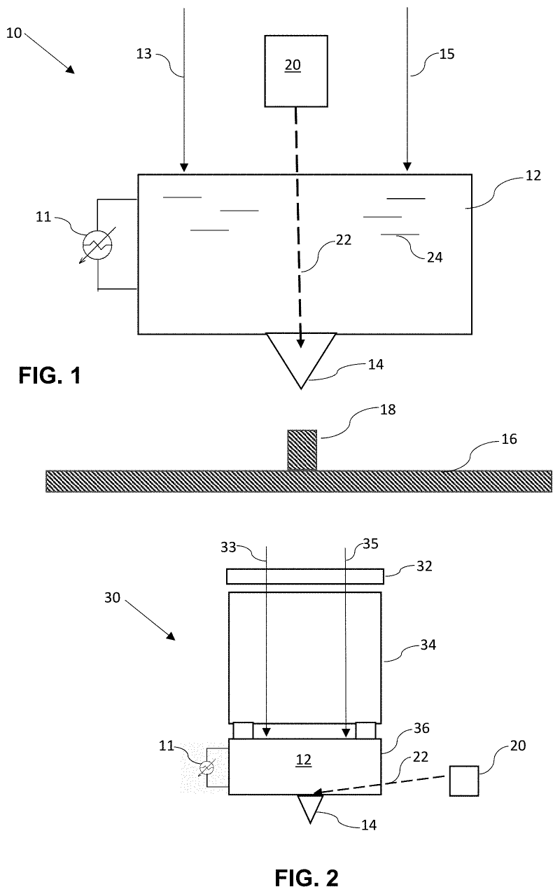

FIG. 1 schematically illustrates a portion of a print head 10 of an additive manufacturing system, also referred to herein as a three-dimensional printer. As illustrated, the print head includes a mixing area 12 that defines a volume within which the contents can be mixed prior to extrusion via a nozzle 14. A system can also include a print bed 16 that can optionally carry a build mandrel 18 that can support a part during formation. The print head 10 opposes the build mandrel 18 and includes the nozzle 14. The mixing area 12 is in thermal association with a heater 11 that heats the contents of the mixing area 12 such that the mixed contents are at a flowable state prior to extrusion at the nozzle 14.

The mixing area 12 includes at least two inlets 13, 15 via which precursor materials can be fed to the mixing area 12. As stated, a print head 10 can include at least two inlets 13, 15 to a mixing area 12, but it should be understood that the disclosed systems are in no way limited to combination of two precursor materials, and additional inlets to a mixing area 12 are encompassed herein as is only a single inlet that provides a single precursor material to the mixing area 12. The precursor materials can be fed to the mixing area independently as either a solid or a liquid. If fed as a solid, a precursor material can be melted or otherwise liquified within the mixing area 12. Within the mixing area 12, the precursor materials can be heated and mixed to form a liquified mixture at a flowable state and within which components of the different precursor materials can intimately contact one another.

In one embodiment, the mixing area 12 can include one or more mixing elements that can encourage intimate mixing of the precursor materials. For instance, the mixing area can include a passive mixing methodology, such as series of baffles 24. As the liquid precursor materials pass through the mixing area 12, the baffles 24 can encourage mixing of the different precursor materials that are fed to the mixing area via the inlets 13, 15. In some embodiments, the system can include powered mixing elements such as a mixer or stirrer as are known in the art that can actively mix the liquified precursor materials and form a liquified mixture.

The system also includes an energy source 20 that is configured to emit an emission 22 and deliver the emission to the interior of the mixing area. More specifically, the emission 22 can be delivered to a location within the mixing area 12 that is at or near the nozzle 14. During use, energy of the emission 22 can contact the liquified mixture of the precursor materials and encourage a reaction of one or more components of the mixture. More specifically, upon interaction of a component of a precursor material with energy of the emission and, optionally, also with one or more other components in the mixing area, a modification to the precursor material can occur that can lead to formation of a solidified (or solidifiable) product that is extruded from a nozzle. For instance, in the particular embodiment of FIG. 1, upon interaction of at least one component of a first precursor material provided to the mixing area 12 via a first inlet 13 and at least one component of a second precursor material provided to the mixing area 12 via a second inlet 15 with energy of the emission, a reaction can occur. The reaction can lead to formation of a solidified product that is a component of a polymeric composition extruded from the nozzle 14 and laid down on the print bed 16, a mandrel 18 held on the print bed 16, or a previous layer of the nascent product being built according to the method.

The type and quality of the emission 22 of the energy source 20 can vary depending upon the reaction to be encouraged by the emission. For instance, the energy source 20 can be designed to encourage localized heating of the liquified mixture at the location of the emission delivery and the increased local temperature can encourage the reaction. In one embodiment, the energy source 20 can deliver energy of a particular wavelength that can interact with a reactant or a catalyst at the particular wavelength of the emission and thereby encourage the reaction.

In one embodiment, the emission 22 can include energy in the ultraviolet (UV) spectrum and/or visible (vis) spectrum. UV emission can include one or more of UVA (wavelength about 400 nm to about 320 nm), UVB (about 320 nm to about 290 nm) and UVC (about 290 nm to about 100 nm). The emission 22 is not limited to UV/vis wavelengths, however, and an energy emission including longer wavelengths (e.g., infrared (IR), near IR, microwave, etc.) or shorter wavelengths (e.g., x-rays) are encompassed herein.

Any suitable energy source 20 may be used, including laser sources. The energy source 20 may be broadband, narrowband, or a single wavelength emission. The energy source 20 may provide continuous or pulsed light during a process. Both the length of time the mixture is exposed to an emission and the intensity of the emission can be varied to determine the ideal reaction conditions.

In one embodiment, the energy source 20 can include a laser configured to deliver a high-power laser beam to the mixing area 12. As utilized herein, a high-power laser may range from as little as 1 Watt to several thousand Watts. A high-power laser beam source typically includes a laser head having a crystal, such as a face-pumped laser that may include, for example, a rectangular cross-sectional shape having six surfaces including respective pumping and cooling surfaces. Laser crystal flashlamps, sometimes referred to as laser flashlamps, positioned within the laser head and along axes parallel to the pumping surfaces, are regularly utilized as pumping means. A high-energy laser system can generally include a solid-state laser source such as a power oscillator that generates a pulse beam, and a gain medium for generating the high-power beam. The amplified beam can be out-coupled or extracted with a generated beam that can range from about 1 Watt to about 5,000 Watts or greater. The optical path of the beam is such that as it is out-coupled from the laser cavity, it is directed onto a series of reflecting surfaces and thereby transmitted to the site in the mixing area 12.

Any suitable laser can be utilized, with a preferred laser generally depending upon the reaction to be catalyzed by the emission of the laser. By way of example, and without limitation, the energy source 20 can include a gas laser, a chemical laser, a dye laser, a metal-vapor laser, a solid-state laser, a semiconductor laser, a free electron laser, a gas dynamic laser, a nickel-like samarium laser, a Raman laser, a nuclear pump laser, or any combination thereof. Gas lasers may include, without limitation, one or more of helium-neon laser, argon laser, krypton laser, xenon ion laser, nitrogen laser, carbon dioxide laser, carbon monoxide laser, and excimer laser. Chemical lasers may include, without limitation, hydrogen fluoride laser, deuterium fluoride laser, chemical oxygen-iodine laser, all gas-phase iodine laser, or any combination thereof. Metal-vapor lasers can include, without limitation, one or more of helium-cadmium, helium mercury, helium selenium, helium silver, strontium vapor laser, neon-copper, copper vapor laser, gold vapor laser, and manganese vapor laser. Solid-state lasers may include, without limitation, ruby laser, neodymium-doped yttrium aluminum garnet laser, neodymium and chromium-doped yttrium aluminum garnet laser, erbium-doped yttrium aluminum garnet laser, neodymium-doped yttrium lithium fluoride laser, neodymium-doped yttrium orthovanadate laser, neodymium-doped yttrium calcium oxoborate laser, neodymium glass laser, titanium sapphire laser, thulium yttrium aluminum garnet laser, ytterbium yttrium aluminum garnet laser, ytterbium₂:O₃ (glass or ceramics) laser, ytterbium-doped glass laser (rod, plate/chip, and fiber), holmium yttrium aluminum garnet laser, chromium zinc selenium laser, cerium-doped lithium strontium (or calcium) aluminum fluoride laser, Promethium¹⁴⁷-doped phosphate glass solid-state laser, chromium-doped chrysoberyl (alexandrite) laser, erbium-doped and erbium-ytterbium co-doped glass lasers, trivalent uranium-doped calcium fluoride solid-state laser, divalent samarium-doped calcium fluoride laser, FARBE center laser, or any combination thereof. Semiconductor laser may include, without limitation, one or more of semiconductor laser diode laser, gallium nitride laser, indium gallium nitride laser, aluminum gallium indium phosphide laser, aluminum gallium arsenide laser, indium gallium arsenide phosphide laser, lead salt laser, vertical cavity surface emitting laser, quantum cascade laser, hybrid silicon laser, or any combination thereof.

The energy emission 22 can be transmitted from the energy source 20 to the targeted site in the mixing area 12 via a suitable transmittance carrier, generally an optical fiber.

Beneficially, disclosed methods and systems can deliver reactive energy to the mixture prior to extrusion while still in the mixing area 12. As such, the energy emission can contact material throughout the breadth of the extrudate and lead to more uniform reaction across the extrudate. In addition, a solidification reaction can begin immediately prior to extrusion and continue through the deposition process. As such, the deposition can provide a nascent solid at the time of contact between the extrudate and the receiving material (a print bed, a mandrel, a previous layer) having the desired extrudate shape that can strongly adhere to the contacting surface.

In one embodiment, the emission can contact curable components of the liquified mixture, and the reaction can form a polymer or a crosslinked polymer network. For instance, in one embodiment, a first precursor material can carry a monomer, an oligomer, or a pre-polymer, and a second precursor material can carry a component that encourages formation of a polymer of the polymeric composition extrudate but does not become a part of the polymerized reaction product, e.g., a photoinitiator or other reaction catalyst. Catalysts can vary depending on the specific reaction to be carried out. Examples of polymerization catalysts can include, without limitation, titanium dioxide, TiO₂, which can function as a photo-initiated catalyst that can lower the activation energy of a polymerization reaction, semiconductors, noble metal nanoparticles, organic catalysts, etc.

In one embodiment, a second precursor material can carry a component that reacts with the component of the first precursor material and becomes a part of the polymerized reaction product, e.g. a crosslinking agent or a monomer, oligomer, or pre-polymer that reacts with a monomeric or polymeric component of the first precursor material to form a larger polymer or crosslinked polymer network.

As used herein, the term “polymer” refers to a molecule composed of repeating structural units connected by covalent chemical bonds. The term encompasses straight chain and branched homopolymers and copolymers including random, block, alternating, segmented, grafted, tapered and other copolymers, as well as crosslinked polymeric networks. An “oligomer” also refers to a polymeric molecule, but refers to a polymer that includes a low number of repeating units, generally equal to or less than 10 repeating units. Thus, the term “polymer” encompasses oligomers. The term “pre-polymer” refers to an oligomer or polymer that can be further reacted via chain extension, crosslinking, branching, etc. to form a larger polymer or crosslinked polymer network.

In one embodiment, the reaction conditions engendered by the energy emission can form a polyurethane, a methacrylate, a polyimide, an epoxy, or a copolymer thereof, e.g., an epoxy acrylate, a modified epoxy acrylate, an epoxy methacrylate, a urethane acrylate, a polypropylene, an aromatic polymer, a polycyclic aromatic (an acene), a polyetherimide, a polyamide, etc. In one embodiment, one of the precursor materials can carry a pre-polymer (e.g., a polyurethane or epoxy polymer that can be present in the mixing area 12 in a flowable state) and another precursor material can carry a crosslinking agent for the pre-polymer, e.g., water in the case of urethanes, or an aromatic amine and/or a polyphenol for epoxies.

In one embodiment, a precursor can carry an oligomer or a pre-polymer, and the emission-initiated reaction can include further polymerization of the pre-polymer, e.g., chain extension and/or crosslinking. By way of example, in one embodiment a precursor material can include a urethane formed by polymerization of diol and diisocyanate monomers and including urethane linkages and the polyurethane pre-polymer can include reactive end-groups, e.g., acrylate or methacrylate end-groups. In such an embodiment, a second precursor material can include a chain extender, e.g., a low molecular weight diol or diamine such as ethylene glycol, butane diol, and propylene glycol, that can react with the reactive end-group functionality to increase the length of the pre-polymer.

In one embodiment, a precursor material can carry an epoxy pre-polymer that can include some crosslinks, but is not fully crosslinked so as to be capable of being mixed with a second precursor material and forming a liquid mixture. In such an embodiment, a second precursor material can carry a catalyst or a crosslinking agent that can further crosslink the epoxy pre-polymer at the reaction conditions engendered by the energy emission immediately prior to extrusion.

In one embodiment, a precursor material can carry a monomer, oligomer, or polymer that contains one or more vinyl functional groups that can react with a second component of the second precursor material prior to extrusion. Vinyl functional groups can be provided by, for example, allyl ethers, vinyl ethers, norbornenes, acrylates, methacrylates, acrylam ides or other monomers, oligomers, or polymers containing vinyl groups. A vinyl-containing component can include other reactive groups in some embodiments, such as a hydroxyl group.

In one embodiment, a reactive component of a precursor material can include one or more thiol functional groups. In one embodiment, a reactive component including a thiol functional group may be reacted with a component of a second precursor material having at least one aliphatic carbon-carbon double bond or at least one aliphatic carbon-carbon triple bond. A thiol-containing component can include other reactive groups in some embodiments, such as a hydroxyl group, a vinyl group, etc.

In one embodiment, a precursor material can carry an initiator, e.g., a photoinitiator or a thermal initiator, that can initiate crosslinking or other reaction upon exposure to the emission 22. Photoinitiators suitable for use in the polymerizable liquid compositions of the invention include, but are not limited to photoinitiators activated by UV or visible light such as 2, 4, 6-trimethylbenzoylphenyl phosphinate (Irgacure® (DTPO-L)), acylgermanes, a bimolecular system of camphorquinone (CQ) and N, N-dimethylaminobenzoic acid ethyl ester (DMAB), bisacylphosphine oxides (Irgacure® 819) and hydroxyalkylphenones (Irgacure® 2959) and I,5-diphenyl-I,4-diyn-3-one (Diinone). Camphorquinone (CQ), N, N-dimethylaminobenzoic acid ethyl ester (DMAB) bisacylphosphine oxides (Irgacure® 819), hydroxyalkylphenones (Irgacure® 2959) and I,5-diphenyld,4-diyn-3-one (Diinone) are biocompatible.

In one embodiment, a precursor material can carry a crosslinking agent that can crosslink a polymer or oligomer carried in a second precursor material upon mixture and combination with an emission 22 of an energy source 20. The crosslinking agent can form links between and among the polymers or oligomers of a second precursor material to form a crosslinked polymer network of the extrudate. A crosslinking agent can be a polyfunctional compound that can react with functionality of a polymer to form crosslinks. In general, a crosslinking agent can be a non-polymeric compound, i.e., a molecular compound that includes two or more reactively functional terminal moieties linked by a bond or a non-polymeric (non-repeating) linking component. By way of example, a crosslinking agent can include, but is not limited to, diacrylates, di-epoxides, poly-functional epoxides, diisocyanates, polyisocyanates, polyhydric alcohols, water-soluble carbodiimides, diamines, diaminoalkanes, polyfunctional carboxylic acids, diacid halides, halo acrylate monomers, and so forth. For instance, when considering a polyurethane-based polymer, a polyfunctional hydroxyl compound can be utilized as a crosslinking agent. An epoxy crosslinked polymer can be prepared from an epoxy prepolymer provided in a first precursor materials and a crosslinking agent, such as an aromatic amine and/or a polyphenol, provided in a second precursor material.

In one embodiment, the interaction of the energy emission with the liquified mixture in the mixing area 12 can form solid particulates dispersed throughout the extrudate. For instance, upon contact of the emission with components of the precursor materials, a reaction could occur forming nano-sized structures in the polymeric extrudate. By way of example, in one embodiment, a polymeric composition extruded from the print head 10 can carry nanoparticles, e.g., metallic nanoparticles or metal oxide nanoparticles, that can be formed within the mixing area 12 via combination of components of the precursor materials with energy of the emission 22. For instance, metallic nanoparticles can be formed within the liquified mixture via reduction of a metal salt carried in one of the precursor materials by use of a base carried in another precursor material. Addition of energy to the liquified mixture by the emission 22 can catalyze the reduction of the metal and formation of metallic nanoparticles in the extrudate. For example, a first precursor solution can carry a metal salt, e.g., gold (III) chloride, and a second precursor solution can carry a suitable reducing agent, e.g., sodium borohydride or the like.

The metal of metallic nanoparticles that can be formed in an extrudate is not particularly limited, provided a cation of the metal can be held in the liquified mixture of the mixing area 12, and can be reduced by a base also carried in the liquified mixture. By way of example, a metal can be a transition metal including, without limitation, chromium, manganese, iron, cobalt, nickel, and copper. In one embodiment, the metal can be a transition metal of the platinum group, such as platinum, palladium, rhodium, ruthenium, silver, or gold. Any suitable base can be used to reduce the metal and form the metallic nanoparticles including, without limitation, reducing agents such as sodium borohydride (NaBH₄), hydrazine (NH₂NH₂), lithium aluminum hydride (LAIN, lithium triethylborohydride (LiEt₃BH), or combinations of reducing agents.

In one embodiment, a precursor material can carry a third component for the formation reaction. For instance, the mixing area 12 can include a third inlet for a third precursor material that can carry a third component, e.g., seed nanoparticles, that can be used to form particles of a desired size/shape in the extrudate.

In those embodiments in which the energy emission catalyzes formation of a particulate in the liquified mixture, the liquified mixture can also carry a polymer that can form a polymeric matrix of an extruded build product. For instance, a polymer, e.g., a thermoplastic polymer, can be fed to the mixing area 12 as a component of a precursor material, and this polymer can be melted within the mixing area and extruded with the nascent particles at the nozzle 14 to be solidified upon deposition.

An energy emission 22 can encourage multiple reactions in the mixing area. Alternatively, multiple energy emissions can be utilized, each of which can encourage a different reaction in a mixing area. For instance, an energy emission 22 can catalyze formation of a particulate in the liquified mixture and can also catalyze a polymerization or crosslinking reaction in the liquified mixture. For example, multiple precursor materials can carry precursors for formation of a polymer of a build product (e.g., a crosslinker, a pre-polymer, a photoinitiator, etc.) and can also carry precursors for formation of particles that can be distributed throughout the extrudate (e.g., a metal cation and a reducing agent). Energy emission for such a system can include a single emission that can encourage both reactions via thermal and/or photoinitiation (e.g., a single broadband emission) or a system can deliver multiple emissions from multiple energy sources, each emission encouraging a specific formation reaction in the liquified mixture.

In embodiments, the liquified mixture extruded from the print head 10 can include additional materials. An additional material of an extruded polymeric composition can be provided in a precursor material that carries a component of the reactive process or can be provided in an additional precursor material, as desired. For instance, in one embodiment, the liquified mixture can include one or more of viscosity modifiers, surfactants, polymers, particulates, fibrous fillers, dyes, colorants, etc. to be included in the build product. Such additive materials can generally be extruded without modification from their initial introduction into the mixing area through extrusion at the nozzle.

A print head 10 can include additional components. For instance, a print head can include a plurality of printing actuators as are known in the art that are configured to move the print head 10 and the print bed 16 relative to one another in at least three degrees of freedom.

FIG. 2 illustrates one embodiment of a print head 30 in which one or more of the precursor materials can be provided to the print head in the form of a solid filament. In such an embodiment, a print head 30 can include a filament drive 32 that drives a filament of a precursor material into the print head 30 at a feed rate. A cold zone 34 positioned between the filament drive 32 and the mixing area 12 can be maintained below a melting temperature of the precursor materials. A controller operatively connected to the heater 11, the filament drive 32, and the printing actuators can execute instructions that can cause the filament drive 32 to move the filaments 33, 35 through the cold zone 34 that is between the filament drive 32 and the mixing area 12. The system can also include a heat break 36 between the cold zone 34 and the mixing area 12 that can provide a thermal transition between the cold zone 34 and the mixing area 12. The cold zone 34 can improve feed to the mixing area 12, preventing early melting of the filaments 33, 35 prior to entry to the mixing area 12.

A control system can include a computer or other suitable processing system that can carry out suitable computer-readable instructions that, when implemented, configure the controller to perform various different functions, such as feeding, heating, extruding, energy emission, etc.

A control system can include a processor(s) and a memory. The processor(s) can be any known processing device. Memory can include any suitable computer-readable medium or media, including, but not limited to, RAM, ROM, hard drives, flash drives, or other memory devices. The memory can be non-transitory. Memory stores information accessible by processor(s), including instructions that can be executed by processor(s). The instructions can be any set of instructions that, when executed by the processor(s), cause the processor(s) to provide desired functionality. For instance, the instructions can be software instructions rendered in a computer-readable form. When software is used, any suitable programming, scripting, or other type of language or combinations of languages may be used to implement the teachings contained herein. Alternatively, the instructions can be implemented by hard-wired logic or other circuitry, including, but not limited to, application-specific circuits. Memory can also include data that may be retrieved, manipulated, or stored by processor(s).

The system can include a network interface for accessing information over a network. The network can include a combination of networks, such as Wi-Fi network, LAN, WAN, the Internet, cellular network, and/or other suitable network and can include any number of wired or wireless communication links. For instance, computing device could communicate through a wired or wireless network with the nozzle 14, the print bed 16, the filament drive 32, and/or the heater 11.

The controller can operate via the software to create a three-dimensional drawing of a desired structure and/or to convert the drawing into multiple elevation layer data. For instance, the design of a three-dimensional structure can be provided to the computer utilizing commercially available CAD software. The structure design can then be sectioned into multiple layers by commercially available layering software. Each layer can have a unique shape and dimension. The layers, following formation, can reproduce the complete shape of the desired structure.

For example, the controller can include software to slice a 3D object using xyz slicing methodology. As in a traditional 3D printing system, the layer files can then be translated to movements of the print head 10, 30 for applying extrudate to a print bed 16 to form the work piece. Numerous software programs have become available that are capable of performing the presently specified functions. For example, AutoLISP can be used to convert AutoCAD drawings into multiple layers of specific patterns and dimensions. CGI (Capture Geometry Inside, currently located at 15161 Technology Drive, Minneapolis, Minn.) can also provide capabilities of digitizing complete geometry of a three-dimensional object and creating multiple-layer data files.

Drawing or “casting on” of the extrudate onto the print bed 16, a mandrel 18, mandrel 32, and/or existing work piece can be accomplished by various methods. For example, the extrudate can be connected or adhered to a needle or other type structure that can draw the extrudate from the print head 10, 30 and apply it to the print bed 16, mandrel 18, and/or existing work piece. As an alternative, the nozzle 14 of the print head 10, 30 may be brought into contact with the print bed 16, the mandrel 18, and/or the existing work piece so as to contact the extrudate, whereby the extrudate adheres to the printing surface 16, mandrel 18, and/or the existing work piece creating an anchor for pulling the extrudate from the print head 10, 30.

While certain embodiments of the disclosed subject matter have been described using specific terms, such description is for illustrative purposes only, and it is to be understood that changes and variations may be made without departing from the spirit or scope of the subject matter.

What is claimed is:

1. An additive manufacturing print head comprising:
a mixing area, the mixing area comprising a first inlet and an outlet;
a nozzle in direct fluid communication with the outlet;
a heater in thermal communication with the mixing area; and
an energy source configured to deliver an emission from the energy source into the mixing area at or near the outlet.

2. The additive manufacturing print head of claim 1, the mixing area comprising a second inlet.

3. The additive manufacturing print head of claim 2, the mixing area comprising one or more additional inlets.

4. The additive manufacturing print head of claim 1, the mixing area comprising a mixing element.

5. The additive manufacturing print head of claim 1, wherein the energy source comprises a laser.

6. The additive manufacturing print head of claim 1, wherein the energy source is configured to deliver an emission comprising X-rays or microwaves.

7. The additive manufacturing print head of claim 1, wherein the energy source is configured to deliver an emission in the ultraviolet and/or visible spectrum.

8. The additive manufacturing print head of claim 1, further comprising a cold zone.

9. The additive manufacturing print head of claim 1, further comprising a filament drive.

10. An additive manufacturing system comprising the print head of claim 1.

11. The additive manufacturing system of claim 10, further comprising a print bed and a controller and optionally comprising a build mandrel.

12. An additive manufacturing process comprising:
feeding a first precursor material to a mixing area;
heating and mixing the first precursor material within the mixing area to form a liquified mixture;
delivering an energy emission from an energy source into the mixing area at or near an outlet of the mixing area, wherein upon the delivery of the energy emission, a component of the first precursor material forms a nascent reaction product within the liquified mixture, the nascent reaction product comprising a solid; and
extruding the liquified mixture comprising the nascent reaction product from the mixing area to a print bed.

13. The process of claim 12, the process further comprising feeding a second precursor material to the mixing area, whereupon delivery of the energy emission a component of the second precursor material interacts with the component of the first precursor material to form the nascent reaction product.

14. The method of claim 13, wherein the first precursor material comprises a polymer, a pre-polymer, or an oligomer, and the second precursor material comprises a crosslinking agent or a chain extender.

15. The method of claim 12, the solid comprising a polyurethane, a methacrylate, a polyimide, an epoxy, or a copolymer thereof.

16. The method of claim 12, the solid comprising particulates.

17. The method of claim 12, wherein the first precursor material comprises a polymer, an oligomer, or a pre-polymer.

18. The method of claim 12, wherein liquified mixture comprises a crosslinking agent and/or a chain extender, and/or an initiator.

19. The method of claim 12, wherein the first precursor material is fed to the mixing area in the form of a solid filament, the solid filament melting in the mixing area.

20. The method of claim 12, wherein the energy emission comprises energy in one or more of the X-ray spectrum, the ultraviolet spectrum, the visible spectrum, the infrared spectrum, and the microwave spectrum.
